(19) United States
(12) Patent Application Publication
(10) Pub. No.: US 2007/0160010 A1
(43) Pub. Date: Jul. 12, 2007

(54) Method and apparatus to perform channel estimation for a communication system

(76) Inventors: Alexander Maltsev, Nizhny Novgorod (RU); Ali S. Sadri, San Diego, CA (US); Alexev V. Khoryaev, Dzerzhinsk (RU); Viktor T. Ermolayev, Nizhny Novgorod (RU); Roman O. Maslennikov, Nizhny Novgorod (RU)

Correspondence Address: John F Kacvinsky;Kacvinsky, 4500 Brooktree Road, Suite 102, Wexford, PA, 15090, US

(21) Appl. No.: 10/597,735

(22) PCT Filed: Feb. 5, 2004
(86) PCT No.: PCT/RU04/00037

§ 371 Date: Aug. 4, 2006

(51) Int. Cl. H04Q 7/00; H04B 3/20

(52) U.S. Cl. 370/332; 370/286

(57) ABSTRACT

A method and apparatus to perform channel estimation for a communication system are disclosed.

### BACKGROUND

A multiple input multiple output (MIMO) system may involve treating a plurality of communications mediums as a single communication channel. For example, a MIMO system may treat a plurality of individual twisted-pair copper wires bundled into a single cable as a single communications channel having multiple inputs and multiple outputs. Information transmitted over a given copper wire, however, may be susceptible to interference from information transmitted over an adjacent copper wire. This condition is typically referred to as “crosstalk.”

The performance of a MIMO system may be significantly increased by reducing the amount of crosstalk in the MIMO channel. One technique to assist in reducing crosstalk is to perform channel estimation of the MIMO channel. Improved channel estimation may result in improved performance of the MIMO system. Consequently, there may be need for improvements in such techniques in a device or network.

### BRIEF DESCRIPTION OF THE DRAWINGS

The subject matter regarded as the embodiments is particularly pointed out and distinctly claimed in the concluding portion of the specification. The embodiments, however, both as to organization and method of operation, together with objects, features, and advantages thereof, may best be understood by reference to the following detailed description when read with the accompanying drawings in which:

FIG. 1 illustrates a MIMO system suitable for practicing one embodiment;

FIG. 2 illustrates a block diagram of a crosstalk filtering module (CFM) in accordance with one embodiment;

FIG. 3 illustrates a programming logic 300 for a CFM in accordance with one embodiment;

FIG. 4 is a graph illustrating the performance of a CFM in accordance with one embodiment;

FIG. 5 illustrates a block diagram of a channel estimator in accordance with one embodiment;

FIG. 6 is a block flow diagram of the programming logic performed by a channel estimator in accordance with one embodiment;

FIG. 7 is a first graph illustrating the performance of a channel estimator in accordance with one embodiment;

FIG. 8 is a second graph illustrating the performance of a channel estimator in accordance with one embodiment; and

FIG. 9 is a third graph illustrating the performance of a channel estimator in accordance with one embodiment.

### DETAILED DESCRIPTION

The embodiments may be directed to a method and apparatus to perform channel estimation for a communication system. The channel estimation technique may be used, for example, to suppress crosstalk in a communication system utilizing a full duplex communications medium such as copper wire twisted pairs, radio-frequencies (RF), and other mediums. Examples of crosstalk may include near end crosstalk (NEXT) and far end crosstalk (FEXT). In one embodiment, for example, the channel estimation technique may be used to perform channel estimation for a multiple input multiple output (MIMO) full duplex wired or wireless communication system using either inter-symbol interference (ISI) or non-ISI channels.

In one embodiment, the channel estimation technique may comprise a threshold scheme for training-based channel estimation. A channel impulse response (CIR) estimate may be found by estimating a maximum-likelihood (ML) estimate, and then refining or improving the ML estimate using a threshold scheme. The result is an improved CIR estimate for a MIMO channel.

In one embodiment, the CIR estimate may be used by a crosstalk suppression scheme to reduce or cancel crosstalk for the MIMO system. The crosstalk suppression scheme may suppress, for example, crosstalk in band-limited channels, and also separates the crosstalk suppression problem from the equalization that provides the ultimate crosstalk suppression level. As a result, the embodiment may use the same equalizer for all outputs of the crosstalk suppression scheme.

Numerous specific details may be set forth herein to provide a thorough understanding of the embodiments of the invention. It will be understood by those skilled in the art, however, that the embodiments of the invention may be practiced without these specific details. In other instances, well-known methods, procedures, components and circuits have not been described in detail so as not to obscure the embodiments of the invention. It can be appreciated that the specific structural and functional details disclosed herein may be representative and do not necessarily limit the scope of the invention.

It is worthy to note that any reference in the specification to “one embodiment” or “an embodiment” means that a particular feature, structure, or characteristic described in connection with the embodiment is included in at least one embodiment. The appearances of the phrase “in one embodiment” in various places in the specification are not necessarily all referring to the same embodiment.

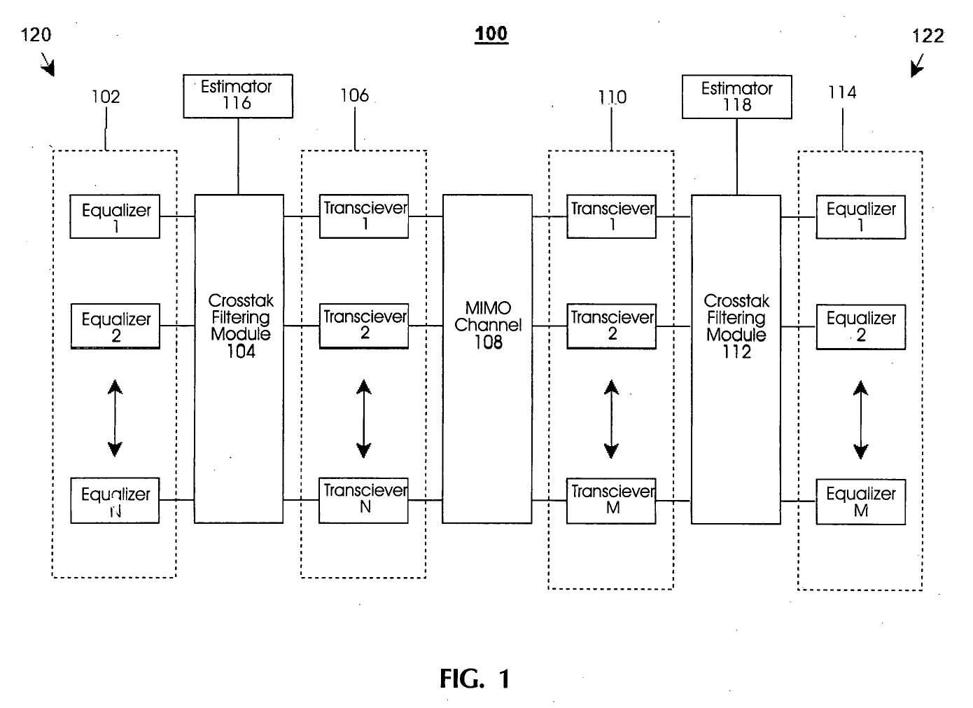

Referring now in detail to the drawings wherein like parts are designated by like reference numerals throughout, there is illustrated in FIG. 1 a system suitable for practicing one embodiment. FIG. 1 is a block diagram of a system 100. System 100 may comprise a plurality of network nodes. The term “network node” as used herein may refer to any node capable of communicating information in accordance with one or more protocols. Examples of network nodes may include a computer, server, switch, router, bridge, gateway, personal digital assistant, mobile device, call terminal and so forth. The term “protocol” as used herein may refer to a set of instructions to control how the information is communicated over the communications medium.

In one embodiment, system 100 may communicate various types of information between the various network nodes. For example, one type of information may comprise “media information.” Media information may refer to any data representing content meant for a user. Examples of content may include, for example, data from a voice conversation, videoconference, streaming video, electronic mail (“email”) message, voice mail message, alphanumeric symbols, graphics, image, video, text and so forth. Data from a voice conversation may be, for example, speech information, silence periods, background noise, comfort noise, tones and so forth. Another type of information may comprise “control information.” Control information may refer to any data representing commands, instructions or control words meant for an automated system. For example, control information may be used to route media information through a network, or instruct a network node to process the media information in a predetermined manner. Both the media and control information may be communicated in a data stream between two or more endpoints. The term “data stream” as used herein may refer to a collection of bits, bytes or symbols sent in series during a data communication session.

In one embodiment, one or more communications mediums may connect the nodes. The term “communications medium” as used herein may refer to any medium capable of carrying information signals. Examples of communications mediums may include metal leads, semiconductor material, twisted-pair wire, co-axial cable, fiber optic, RF spectrum, and so forth. The terms “connection” or “interconnection,” and variations thereof, in this context may refer to physical connections and/or logical connections.

In one embodiment, for example, the network nodes may be connected by communications mediums comprising RF spectrum for a wireless network, such as a cellular or mobile system. In this case, the network nodes and/or networks shown in system 100 may further comprise the devices and interfaces to convert the signals carried from a wired communications medium to RF signals. Examples of such devices and interfaces may include omni-directional antennas and wireless RF transceivers. The embodiments are not limited in this context.

In one embodiment, the network nodes may communicate information to each other in the form of packets. A packet in this context may refer to a set of information of a limited length, with the length typically represented in terms of bits or bytes. An example of a packet length might be 1000 bytes. The packets may be communicated in accordance with one or more packet protocols. For example, in one embodiment the packet protocols may include one or more Internet protocols, such as the Transmission Control Protocol (TCP) and Internet Protocol (IP). The embodiments are not limited in this context.

Referring again to FIG. 1, system 100 may comprise a wired or wireless communication system using a MIMO communication channel. In one embodiment, for example, system 100 may comprise a local area network (LAN) operating in accordance with one or more Ethernet based communication protocols as defined by the Institute for Electrical and Electronic Engineers (IEEE) 802.3 series of standards, such as a Gigabit Ethernet 1000Base-T communication system (“Gigabit Ethernet”), an advanced 10GBase-T communication system, and so forth. Although one embodiment may be illustrated in the context of a Gigabit Ethernet system by way of example, it can be appreciated that any type of communication system employing a MIMO channel may be used and still fall within the intended scope of the embodiments.

FIG. 1 may illustrate the structure of Gigabit Ethernet system 100. As shown in FIG. 1, system 100 may comprise network nodes 120 and 122. Network nodes 120 and 122 may each represent processing systems having Gigabit Ethernet device(s). The Gigabit Ethernet devices may be implemented as part of a network interface card (NIC), for example. More particularly, network node 120 may comprise a set of equalizers (1-N) 102, a CFM (CFM) 104, a set of transmitter/receivers (“transceivers”) (1-N) 106, and a channel estimator 116. Network node 122 may have a similar structure to network 120, and may comprise a set of equalizers (1-M) 114, a CFM 112, a set of transceivers (1-M) 110, and a channel estimator 118. In a typical implementation, M and N are normally equal, although the embodiments are not necessarily limited in this context. Network nodes 120 and 122 may communicate information between each other using a MIMO channel 108. Although only two network nodes and one MIMO channel are shown in FIG. 1 for purposes of clarity, it can be appreciated that any number of network nodes and MIMO channels may be used and still fall within the scope of the embodiments.

System 100 may operate to communicate information between network nodes 120 and 122 at communication speeds of approximately 1000 megabits per second (Mbps). The 1000 Mbps full duplex data throughput may be achieved using MIMO channel 108. MIMO channel 108 may comprise, for example, four pairs of twisted pair coppers wires bundled in a Category 5 (CAT-5) cable. Each pair may transmit a 250 Mbps data stream encoded into a 4-dimension 5-level pulse amplitude modulation (4-D PAM-5) signal constellation. In essence, the four pairs of CAT-5 unshielded twisted pair (UTP) wiring may be treated as one channel with four inputs and four outputs. Hence, each network node may contain four similar transceivers, one for each pair of physical wire. For example, each of the transmitters of transceivers 1-N may be paired with a corresponding receiver of transceivers 1-M. Hybrid circuits (not shown) may facilitate bidirectional data transmission on the same wire.

During the initialization of system 100, the paired transceivers may go through a training phase in an attempt to characterize MIMO channel 108. Channel estimators 116 and 118 may control or assist in the training phase. Signals may be communicated between the respective transmitters and receivers, and at least one characteristic of MIMO channel 108 may be measured, such as channel impulse responses, amplitude levels, shapes of the signals, signal distortion, crosstalk impulse responses, temporal shifts and delays, and so forth. The communicated signals received by the receiving device are predetermined signals, and deviancies from the expected values are noted by the receiving device.

One factor that can result in deviancies is crosstalk noise. Crosstalk noise, such as FEXT noise, may result when the energy from a signal in one communications path or data stream interferes with the signal in one or more other communication paths or data streams. That is, crosstalk noise represents unwanted coupling between two or more transmitting pairs as the signal propagates from the transmit end of the pair to the receiving end. Crosstalk noise may impact the ability of the receiver to decode a particular data stream, and also may impair the speed or bandwidth for MIMO channel 108.

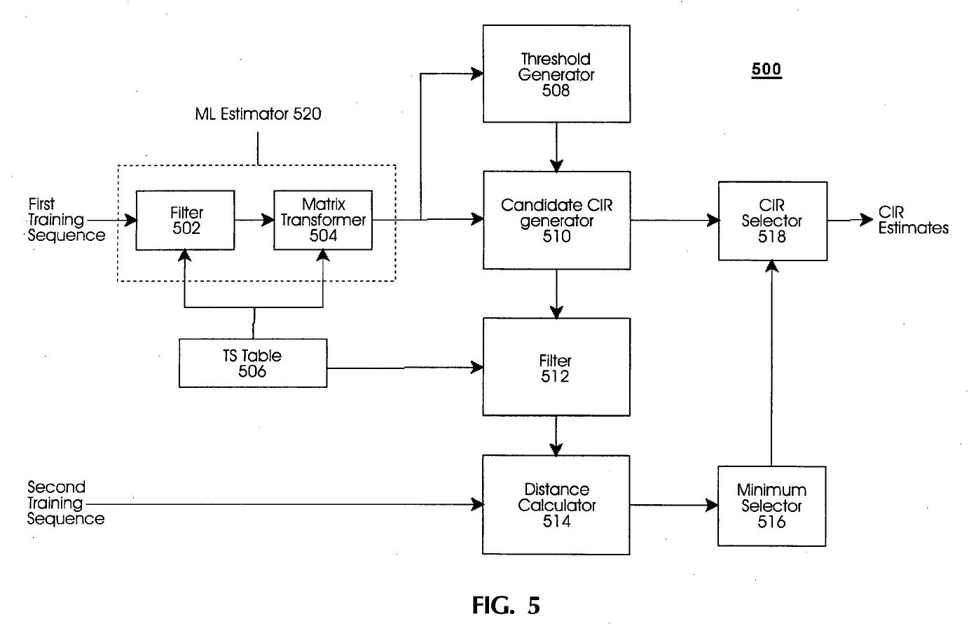

In one embodiment, channel estimators 116 and 118 may be used to perform channel characterization for MIMO channel 108 in an effort to estimate potential crosstalk noise. Channel estimators 116 and 118 may estimate a plurality of channel impulse response values for MIMO channel 108. Channel estimators 116 and 118 may estimate a channel impulse response value between each transmitter and each receiver. Consequently, for a MIMO system with N transmitters and M receivers, N×M impulse responses should be obtained after the training phase. These channel impulse responses may then be used to construct a MIMO channel impulse response matrix. Accordingly, channel estimators 116 and 118 pass the channel impulse response values to CFMs 104 and 112, respectively. CFMs 104 and 112 may use the channel impulse response values to assist in creating an appropriate filter for suppressing the crosstalk noise. The channel estimate scheme may be discussed in more detail with reference to FIGS. 5-9.

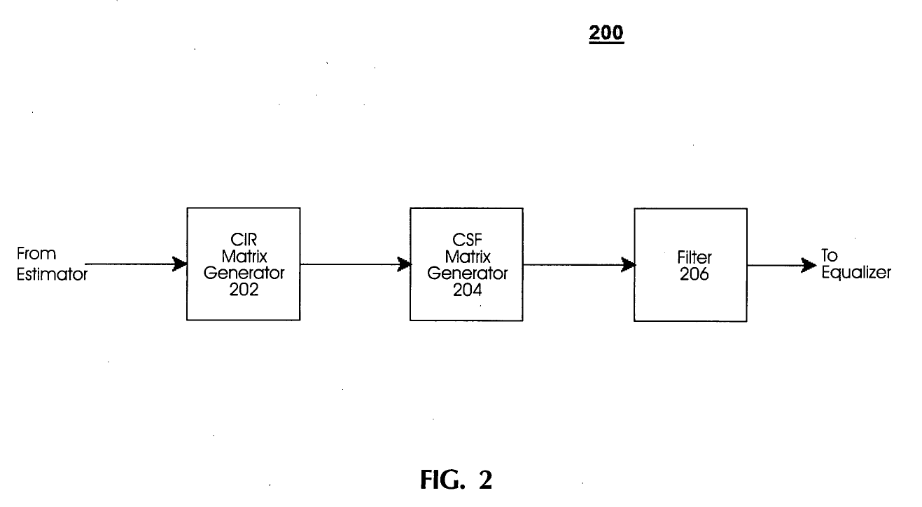

In one embodiment, for example, CFMs 104 and 112 may receive the CIR estimate from channel estimators 116 and 118, respectively. Each CFM may use the CIR estimate to synthesize or create a filter to assist in reducing or canceling crosstalk noise at a receiver coupled to MIMO channel 108. Therefore, in one embodiment the filter may be synthesized after the training phase. CFMs 104 and 112 may be discussed in more detail with reference to FIG. 2.

Channel Filtering

FIG. 2 may illustrate a CFM in accordance with one embodiment. FIG. 2 may illustrate a CFM 200. CFM may be representative of, for example, CFMs 104 and 112. In one embodiment, CFM 200 may comprise one or more modules. For example, in one embodiment 200 may comprise a channel impulse response (CIR) matrix generator 202, a crosstalk suppression filter (CSF) matrix generator 204, and a filter 206. Although these modules may be described by way of example, it can be appreciated that a greater or lesser number of modules may be used and still fall within the scope of the embodiments. Further, although the embodiment has been described in terms of “modules” to facilitate description, one or more circuits, components, registers, processors, software subroutines, or any combination thereof could be substituted for one, several, or all of the modules.

As shown in FIG. 2, CIR matrix generator 202 may receive one or more measured values (e.g., measured channel impulse responses) from a channel estimator, such as channel estimators 116 and 118. CIR matrix generator 202 may use the measured value(s) to construct a CIR matrix.

In one embodiment, the CIR matrix may represent a description of how a communication medium such as MIMO channel 108 alters the signal that is being transmitted between two endpoints, such as network nodes 120 and 122. With any practical channel the inevitable filtering effect will cause a spreading of individual data symbols passing through the communications channel. The CIR matrix attempts to characterize or describe how the propagation of a transmitted signal induces a signal at the receiver. It is possible to express the channel in terms of an impulse response, that is, the signal that would be received were an impulse to be transmitted. In one embodiment, for example, the CIR matrix may characterize MIMO channel 108 as a generic N-input and M-output MIMO system composed of P-tap finite impulse response (FIR) filters expressed in matrix form. Once the CIR matrix is generated, CIR matrix generator 202 may send the generated CIR matrix to CSF matrix generator 204.

In one embodiment, CSF matrix generator 204 may receive the CIR matrix. CSF matrix generator 204 may generate a CSF matrix using the received CIR matrix. The CSF matrix may represent a matrix filter constructed using the CIR values approximated by the FIR filters. The CSF matrix is synthesized using the CIR matrix in an attempt to reduce or eliminate crosstalk for MIMO channel 108. Once the CSF matrix is generated, CSF matrix generator 204 may send the generated CSF matrix to filter 206.

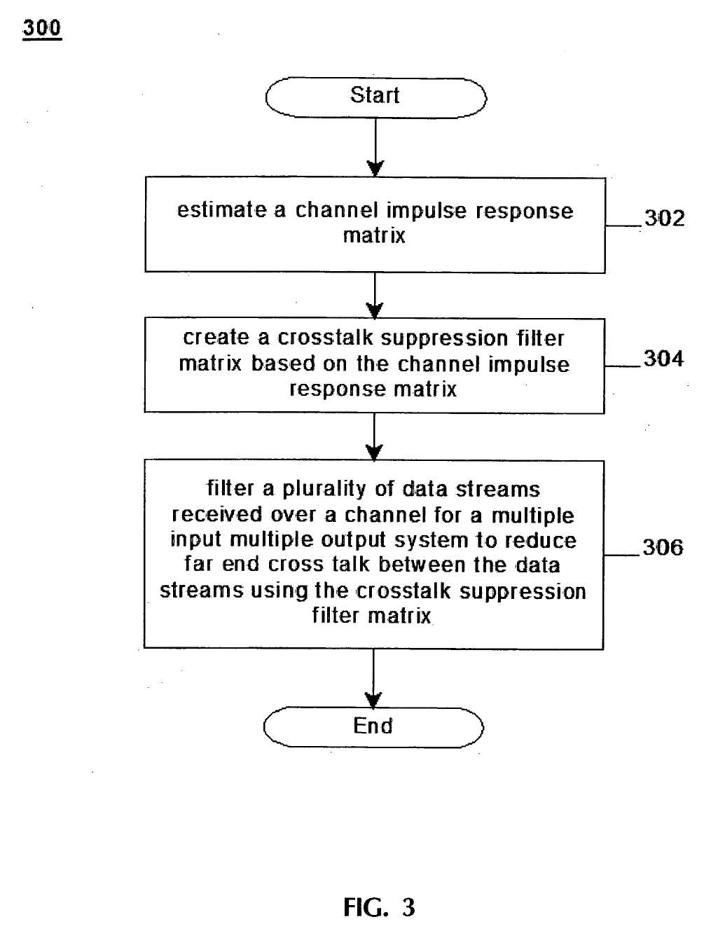

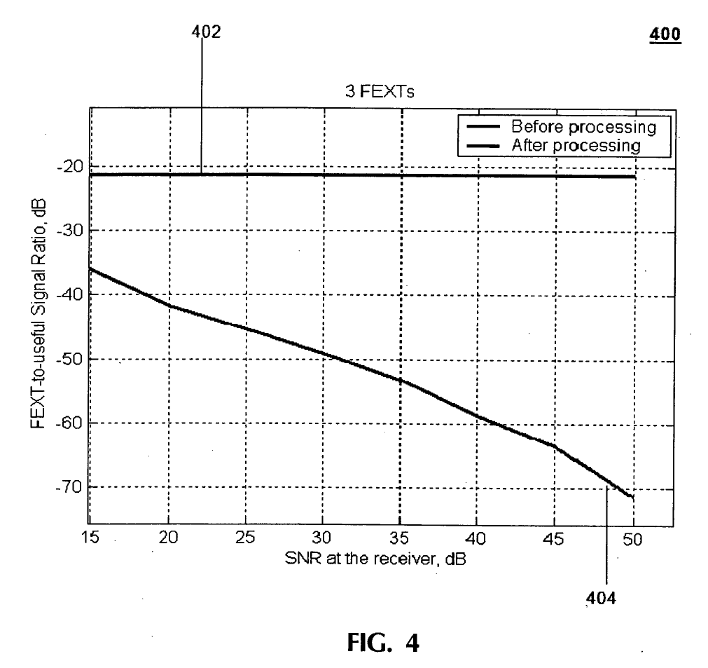

In one embodiment, filter 206 may receive the CSF matrix. Filter 206 may use the CSF matrix to filter crosstalk noise from one or more data streams communicated using MIMO channel 108. The CIR matrix, CSF matrix and filter 206 may be described in more detail with reference to FIGS. 3 and 4.

The operations of systems 100 and 200 may be further described with reference to FIGS. 3 and 4 and accompanying examples. Although the figures presented herein may include a particular programming logic, it can be appreciated that the programming logic merely provides an example of how the general functionality described herein can be implemented. Further, the given programming logic does not necessarily have to be executed in the order presented unless otherwise indicated. In addition, although the given programming logic may be described herein as being implemented in the above-referenced modules, it can be appreciated that the programming logic may be implemented anywhere within the system and still fall within the scope of the embodiments.

FIG. 3 illustrates a programming logic 300 for a CFM in accordance with one embodiment. As shown in programming logic 300, a CIR matrix may be estimated at block 302. A CSF matrix may be created based on the CIR matrix at block 304. The CIR matrix and CSF matrix may have a similar structure and matrix dimension. A plurality of data streams received over a channel for a MIMO system may be filtered using the CSF matrix to reduce crosstalk at block 306. The data streams may each comprise, for example, an ISI or non-ISI signal. The filtered data streams may then be equalized by one or more equalizers using the same or similar equalization parameters.

In one embodiment, the CIR matrix may be estimated by estimating at least one channel characteristic for the MIMO channel. A plurality of channel impulse response elements may be estimated based on the channel characteristic. The CIR matrix may be created using the channel impulse response elements.

The operation of systems 100 and 200, and the programming logic shown in FIGS. 3 and 4, may be better understood by way of example. As discussed previously, CFM 200 may estimate a CIR matrix, and then synthesize a CSF matrix for use in filtering crosstalk noise from a MIMO channel, such as MIMO channel 108. For purposes of this example, assume a bi-directional Gigabit Ethernet system having a MIMO channel with 4 inputs and 4 outputs, as shown in system 100. Consider the general case of a linear, dispersive, and noisy digital communication MIMO system with m₀ inputs and m₀ outputs. The signals at the j-th channel output (1≦j≦m₀) have the standard form:

$${y}_{i} ( t ) = {\sum }_{i = 1}^{{m}_{0}} {h}_{ij} ( t ) ⊗ {s}_{j} ( t ) + {n}_{i} ( t ) \qquad ( 1 )$$

where yᵢ(t)-i-th channel output, hᵢⱼ(t)—channel impulse response between the j-th input and the i-th output, sⱼ(t)—the j-th channel input signal, nᵢ(t)—noise at the i-th output.

In discrete form the equation (1) may be rewritten as follows:

$${y}_{i} ( k ) = {\sum }_{j = 1}^{{m}_{0}} {\sum }_{m = 0}^{{L}_{ij}} {h}_{ij} ( m ) \cdot {s}_{j} ( k - m ) + {n}_{i} ( k ) ; \qquad ( 2 )$$

where hᵢⱼ(m)—tap gain coefficients of finite impulse response of the equivalent discrete-time channel between the j-th input and the i-th output, whose memory is denoted by Lᵢⱼ, the sⱼ(m) nᵢ(m) yᵢ(m)—are sampled versions of the sⱼ(t), nᵢ(t), yᵢ(t) respectively.

By grouping the received signals from all m₀ channel outputs into a column vector y(t) the equation (1) is expressed in matrix form:
y(t)=H(t)\textcircled{X}s(t)+n(t), (3)
where, y(t) m₀×1 vector of the received signals, H(t)—is the m₀×m₀ MIMO channel impulse response matrix, s(t)—m₀×1 vector of the transmitted signals, n(t)—noise vector.

In discrete form the equation (3) can be written as following:

$$y ( k ) = {\sum }_{m = 0}^{v} H ( m ) s ( k - m ) + n ( k ) \qquad ( 4 )$$

where v is the maximum length of all of the m₀×m₀ channel impulse responses, i.e., v=max_{i,j}Lᵢⱼ. Note that in these notations the non-diagonal elements of the CIR matrix H(t) represent the undesirable crosstalk impulse responses and introduce the unwanted interference (i.e., crosstalk) into useful signal from the adjacent pairs (or parallel spatial channels for wireless communication system) and these interferences are removed by CFM 200.

In this example, assume that system 100 reduces crosstalk noise by performing the following operations. As an initial matter, the overall channel characteristics of system 100 should be defined. Any given channel estimation technique may be used to define the channel characteristics. The particular channel estimation technique used for a given implementation may be defined by the level of crosstalk suppression desired, which in turn depends on the accuracy properties of estimate.

Once the channel estimation operation is fulfilled, the complete CIR matrix Ĥ(t) may be constructed at the receiver end. This matrix may contain a set of CIR matrix values approximated by the FIR filters, which may be represented as follows:

$$\hat{H} ( t ) = ( \begin{matrix}{\hat{h}}_{11} ( t ) & … & {\hat{h}}_{1 j} ( t ) & … & {\hat{h}}_{1 {m}_{0}} ( t ) \\ ⋮ & … & ⋮ & … & ⋮ \\ {\hat{h}}_{i 1} ( t ) & … & {\hat{h}}_{ij} ( t ) & … & {\hat{h}}_{{im}_{0}} ( t ) \\ ⋮ & … & ⋮ & … & ⋮ \\ {\hat{h}}_{{m}_{0} 1} ( t ) & … & {\hat{h}}_{{m}_{0} j} & … & {\hat{h}}_{{m}_{0} {m}_{0}} ( t )\end{matrix} ) . \qquad ( 5 )$$

To suppress the crosstalk in each channel output, a crosstalk suppression filter Q(t) may be applied to process the received signals. This filter may be synthesized using the CIR matrix Ĥ(t).

The algorithm of the crosstalk filter Q(t) calculation may comprise several stages. The following operations may calculate the elements qᵢⱼ(t) i, j=1, . . . , m₀ of the crosstalk suppression filter:
1. CIR matrix Ĥ(t) may be transposed. The transpose of the CIR matrix may be calculated by interchanging rows and columns.
2. Each element of the obtained matrix may be substituted on its minor. During a minor calculation the convolution operation is applied instead of the multiplication operation.
3. The sign for the minor values may be determined. The sign for the minor values may change from + (plus) to − (minus) for minors with the odd sum of indexes.
   As a result of the above operations, a m₀×m₀ crosstalk suppression filter(s) may be constructed.

Obtained such way the matrix Q(t) comprises the crosstalk suppression filter.

As shown above, the performance of the crosstalk suppression filter may rely upon the measured channel characteristics. Assuming perfect channel knowledge, CFM 200 may completely eliminate crosstalk noise from MIMO channel 108. In the noise-free channel the output of the crosstalk suppression filter can be written as:
x(t)=Q(t)\textcircled{X}y(t)=Q(t)\textcircled{X}H(t)\textcircled{X}s(t)=G(t)\textcircled{X}s(t) (6)
where m₀×m₀ matrix filter G(t) has the diagonal form with the same elements g(t) on the main diagonal. Therefore the outputs of the matrix crosstalk suppression filter are crosstalk-free signals:
xⱼ(t)=g(t)\textcircled{X}sⱼ(t). (7)

To further describe the operation of system 100, consider a lesser complex case of a MIMO system having two inputs and two outputs, without noise. In this case equation (1) gives the relationship between input and output signals in the form
y₁(t)=h₁₁(t)\textcircled{X}s₁(t)+h₁₂(t)\textcircled{X}s₂(t);
y₂(t)=h₂₁(t)\textcircled{X}s₁(t)+h₂₂(t)\textcircled{X}s₂(t); (8)
The CIR matrix may be represented as

$$H ( t ) = [ \begin{matrix}{h}_{11} ( t ) & {h}_{12} ( t ) \\ {h}_{21} ( t ) & {h}_{22} ( t )\end{matrix} ] .$$

Assuming perfect channel estimation, the crosstalk suppression filter may be represented as

$$Q ( t ) = [ \begin{matrix}{h}_{22} ( t ) & - {h}_{12} ( t ) \\ - {h}_{21} ( t ) & {h}_{11} ( t )\end{matrix} ] .$$

The output signals of this filter may be described by the following equation:
x₁(t)=[h₂₂(t)\textcircled{X}h₁₁(t)−h₁₂(t)\textcircled{X}h₂₁(t)]\textcircled{X}s₁(t)
x₂(t)=[h₁₁(t)\textcircled{X}h₂₂(t)−h₂₁(t)\textcircled{X}h₁₂(t)]\textcircled{X}s₂(t) (9)

As seen from equation (9), the output signals may be crosstalk-free signals. Note that the complete impulse responses of both outputs are approximately equal. This means that the same equalizers may be applied at the output of the crosstalk suppression filter.

FIG. 4 is a graph illustrating the performance of a CFM in accordance with one embodiment. FIG. 4 may illustrate the performance of a CFM using a MIMO channel comprising unshielded twisted pair copper medium CAT-5 cable. FIG. 4 was plotted for an Ethernet LAN system having 4 pairs of twisted pair cable. In such a system, free transmitters may simultaneously induce crosstalk at the receiver end. A curve 402 illustrates the total crosstalk to useful signal ratio before using a CFM. A curve 404 illustrates the total crosstalk to useful signal ratio after using a CFM. As illustrated by FIG. 4, the use of a CFM provides crosstalk suppression such that the residual crosstalk noise is less than the channel noise floor.

Channel Estimation

As discussed previously, channel estimators 116 and 118 may use a channel estimation technique to estimate one or more characteristics of a channel, such as MIMO channel 108. For example, channel estimators 116 and 118 may estimate a CIR estimate. The CIR estimate may then be used by a crosstalk filtering module, such as CFM 104 and CFM 112, to synthesize a filter to assist in reducing or canceling crosstalk noise at a receiver coupled to MIMO channel 108. The performance of the CFM may increase in accordance with the accuracy of the CIR estimate. FIGS. 5-9 discuss such an improved channel estimate technique.

In one embodiment, channel estimators 116 and 118 may use a channel estimation technique comprising a threshold scheme for training-based channel estimation. A CIR estimate may be found by estimating a ML estimate, and then refining or improving the ML estimate using a threshold scheme. The result is an improved CIR estimate for a MIMO channel, such as MIMO channel 108.

The ML estimate is known to be a minimum-variance unbiased estimate. The ML estimate, however, may be unsatisfactory for a number of reasons. For example, the ML estimate of a channel does not provide a channel length L. In the absence of a predetermined channel length, the ML estimate may use the maximum possible channel length. The real channel, however, can often be shorter then the maximum possible channel length. In this case, the ML estimate may have false taps due to channel noise. The impact of false taps on the accuracy of the CIR estimate will increase as the difference between the length of the real channel and maximum possible channel length increases. In another example, the ML estimate may provide a minimum variance of estimate error if the noise is Gaussian white noise. In practice, however, the background channel noise can be different from Gaussian white noise. For example, the alien noise in cable bundles does not comprise Gaussian white noise since it is induced by signals from other cables.

One embodiment may comprise a channel estimate scheme to compensate for these and other problems. The channel estimate scheme may use a threshold scheme to refine an ML estimate. As a result, channel estimators 116 and 118 may generate a more accurate CIR estimate relative to existing techniques. The CIR estimate may be used to reduce crosstalk noise in a communication system using a MIMO channel, such as MIMO channel 108.

FIG. 5 illustrates a block diagram of a channel estimator in accordance with one embodiment. FIG. 5 illustrates a channel estimator 500. In one embodiment, channel estimator 500 may be representative of, for example, channel estimator 116 and 118. Channel estimator 500 may comprise a plurality of modules. Although these modules may be described by way of example, it can be appreciated that a greater or lesser number of modules may be used and still fall within the scope of the embodiments. Further, although the embodiment has been described in terms of “modules” to facilitate description, one or more circuits, components, registers, processors, software subroutines, or any combination thereof could be substituted for one, several, or all of the modules.

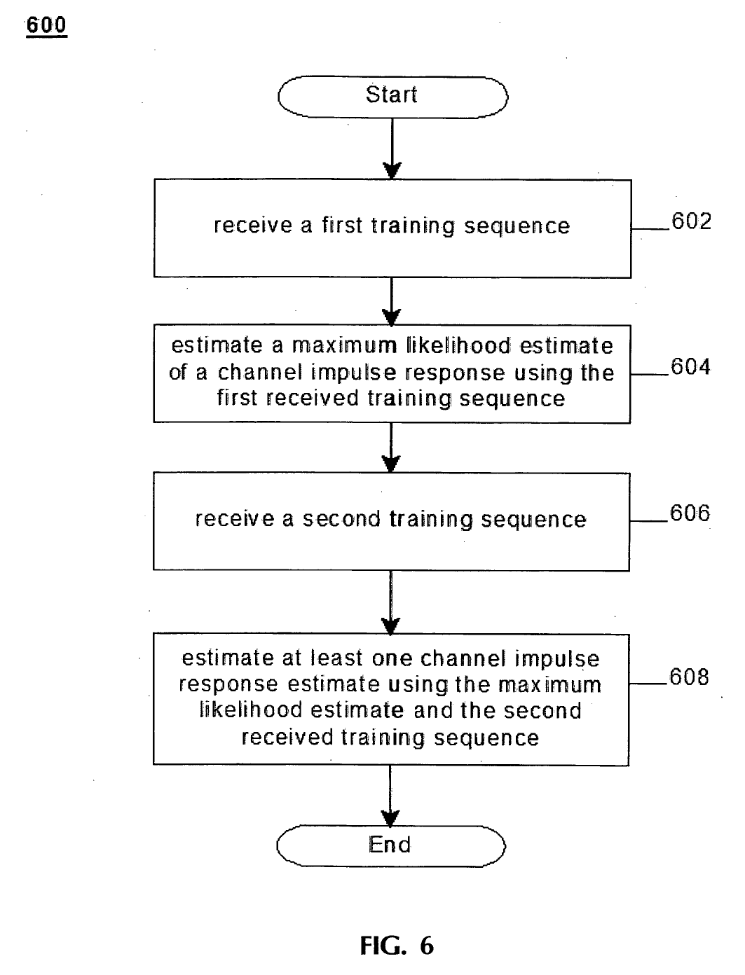

In one embodiment, channel estimator 500 may comprise a ML estimator 520. ML estimator 520 may further comprise a filter 502 connected to a matrix transformer 504. ML estimator 520 may have access to a training sequence (TS) table 506. ML estimator 520 may also be connected to a threshold generator 508 and a candidate CIR generator 510, both of which are connected to each other. Candidate CIR generator 510 may be connected to a filter 512. Filter 512 may also access TS table 506. Filter 512 may be connected to a distance calculator 514. Distance calculator 514 may be connected to a minimum selector 516. Minimum selector 516 may be connected to CIR selector 518. The operation of channel estimator 500 may be further described with reference to FIGS. 6-9.

FIG. 6 is a block flow diagram of the programming logic performed by a channel estimator in accordance with one embodiment. FIG. 6 illustrates a programming logic 600. Programming logic 600 may illustrate operations to perform channel estimation. For example, a first training sequence may be received at block 602. A ML estimate of a channel impulse response may be estimated using the first received training sequence at block 604. A second training sequence may be received at block 606. At least one CIR estimate may be estimated using the ML estimate and the second received training sequence at block 608.

In one embodiment, the ML estimate may be estimated by filtering the first received training sequence using a filter. The filter may be matched to the first received training sequence. The output of the filter may be a first set of vectors for a matrix. The matrix may be transformed to form the ML estimate.

In one embodiment, the CIR estimate may be estimated by receiving the ML estimate. A set of threshold values may be generated using the ML estimate. A set of candidate CIR estimate vectors may be generated using the threshold values. A CIR estimate may be selected from the candidate CIR estimate vectors.

In one embodiment, the set of threshold values may be generated by solving the following equation:

$${t}_{j} = \frac{{max}_{k = 0 , L - 1} \vert {\hat{h}}_{k}^{ML} \vert}{N} j$$

where t=[t₁, . . . , t_{N}] is a set of thresholds, j=1, . . . , N, L represents a channel impulse response length, ĥ^{ML} represents said ML estimate, ĥₖ^{ML} represents the k-th tap of ML estimate of said channel impulse response, and k=0, . . . , L−1.

In one embodiment, the candidate CIR estimate vectors may be generated by solving the following equation:

$${\hat{h}}_{k}^{( j )} = \{ \begin{matrix}{\hat{h}}_{k}^{ML} , & if \vert {\hat{h}}_{k}^{ML} \vert \geq {t}_{j} \\ 0 , & if \vert {\hat{h}}_{k}^{ML} \vert < {t}_{j}\end{matrix}$$

where ĥ^{(j)}=[ĥ⁽¹⁾, . . . , ĥ^{(N)}] is a set of candidate CIR estimates, j=1, . . . , N, ĥₖ^{(j)} is k-th tap of j-th candidate CIR estimate vectors, t=[t₁, . . . , t_{N}] is a set of thresholds, and ĥ^{ML} represents said ML estimate.

In one embodiment, the CIR estimate may be selected from the candidate CIR estimate vectors. The first received training sequence, which is known to the receiver, may be filtered using the candidate CIR estimate vectors to form a second set of vectors. A set of distance values between the second set of vectors and the second received training sequence may be determined. A minimum distance value may be selected from the set of distance values. The CIR estimate vector may be selected using the minimum distance value.

In one embodiment, the CIR estimate may be used to filter crosstalk from a communication channel, such as MIMO channel 108, for example. The CIR estimate may be received at a CFM to form a CIR matrix. A CSF matrix may be created based on the CIR matrix. A plurality of data streams received over a channel for a MIMO output system may be filtered to reduce crosstalk between the data streams using the CSF matrix.

The operation of system 500, and the programming logic shown in FIG. 6, may be better understood by way of example. Continuing with the example described with reference to FIGS. 1-3, CFM 200 may estimate a CIR matrix, and then synthesize a CSF matrix for use in filtering crosstalk noise from a MIMO channel, such as MIMO channel 108. The CIR matrix may be estimated using a CIR estimate generated by channel estimator 500.

In this example, channel estimator 500 may implement a threshold scheme for training-based channel estimation. The CIR estimate may be derived from an ML estimate. Once the ML estimate is generated, it may be improved using a threshold technique. Since the scheme is training-based, the CIR estimate may be obtained using a known training sequence and its corresponding observations. In one embodiment, the threshold scheme transmits and receives the same training sequence at least twice. The training sequence may be a known training sequence optimal used for ML estimation.

The received symbols of the TS transmitted for the first time are:

$${y}_{i}^{( 1 )} = {\sum }_{k = 0}^{L - 1} {s}_{i - k + L - 1} {h}_{k} + {n}_{i}^{( 1 )} , i = 1 , … , M - L + 1 \qquad ( 10 )$$

where sⱼ (j=1, . . . , M) is the symbol for the training sequence, hₖ (k=0, . . . ,L−1) is the tap of CIR, L is the CIR length and nᵢ⁽¹⁾ is the sample of the additive channel noise.

The received symbols of the training sequence transmitted for the second time are:

$${y}_{i}^{( 2 )} = {\sum }_{k = 0}^{L - 1} {s}_{i - k + L - 1} {h}_{k} + {n}_{i}^{( 2 )} , i = 1 , … , M - L + 1 \qquad ( 11 )$$

where nᵢ⁽²⁾ is the other realization of the channel noise.

By comparing equations (10) and (11) it can be seen that the received training sequences differ principally in noise realizations. This may be particularly useful when evaluating threshold technique performance as discussed further below.

Equation (10) can be rewritten in a matrix-vector form as:
y⁽¹⁾=Sh+n⁽¹⁾ (12)
where h=[h₀, . . . , h_{L-1}]^{T} is unknown CIR, that should be estimated, and n⁽¹⁾ is the noise vector, S is (M-L+1)×L -dimensional matrix with entries Sᵢⱼ=s_{L+(i-j)}, y⁽¹⁾ is the vector of the received signals.

The first received training sequence y⁽¹⁾ is used to obtain the maximum-likelihood estimate (MLE) of the CIR h. Using notations (12) the ML estimate of CIR is given by [10, 11]:
ĥ^{ML}=(S^{T}S)⁻¹S^{T}y⁽¹⁾ (13)

Referring again to FIG. 5, filter 502 of ML estimator 520 receives a first training sequence. The first vector S^{T}y⁽¹⁾ is found as the output of filter 502. Filter 502 may be a filter appropriately matched to the training sequence. Matrix transformer 504 receives the output of filter 502, and applies the matrix transformation (S^{T}S)⁻¹. Matrix (S^{T}S)⁻¹ is a function of only the first received training sequence, and therefore it may be known at the receiver and pre-computed accordingly. The output of ML estimator 520 is the ML estimate ĥ^{ML}.

After the ML estimate ĥ^{ML} of the CIR is obtained, threshold generator 508 generates the set of thresholds t=[t₁, . . . , t_{N}] in accordance with the following equation:

$${t}_{j} = \frac{{max}_{k = 0 , L - 1} \vert {\hat{h}}_{k}^{ML} \vert}{N} j , n = 1 , … , N \qquad ( 14 )$$

Candidate CIR generator 510 may receive the set of thresholds and use them to form the set of CIR estimates [ĥ⁽¹⁾, . . . , ĥ^{(N)}]. Each estimate ĥ^{(j)} may be obtained using the following rule:

$${\hat{h}}_{k}^{( j )} = \{ \begin{matrix}{\hat{h}}_{k}^{ML} , & if \vert {\hat{h}}_{k}^{ML} \vert \geq {t}_{j} \\ 0 , & if \vert {\hat{h}}_{k}^{ML} \vert < {t}_{j}\end{matrix} j = 1 , … , N ; k = 0 , … , L - 1 \qquad ( 15 )$$

Candidate CIR generator 510 then outputs the generated set of N CIR estimates. The CIR estimates may be in the form of vectors, for example.

Channel estimator 500 may then proceed to select the best CIR estimate from the set of generated CIR estimates. Filter 512 may receive the candidate CIR estimates and convolute each one with the training sequence in accordance with the following equation:

$${b}_{i}^{( j )} = {\sum }_{k = 0}^{L - 1} {s}_{i - k + L - 1} {\hat{h}}_{k}^{( j )} j = 1 , … , N ; i = 1 , … , M - L + 1 \qquad ( 16 )$$

Thus the set of vectors [b⁽¹⁾, . . . , b^{(N)}] may be generated.

Distance calculator 514 may receive the set of vectors [b⁽¹⁾, . . . , b^{(N)}] and calculate the distances [d₁, . . . , d_{N}] between the obtained vectors [b⁽¹⁾, . . . , b^{(N)}] and the second received training sequence y⁽²⁾ in accordance with the following equation:

$${d}_{j} = ‖ {b}^{( j )} - {y}^{( 2 )} ‖ j = 1 , … , N \qquad ( 17 )$$

Minimum selector 516 may receive the distances [d₁, . . . , d_{N}] between the obtained vectors, and select the vector b^{(j}^{₀}⁾, which has the minimum distance dⱼ_{₀} in accordance with the following equation:
j₀=arg min dⱼ (18)

The value dⱼ_{₀}² has a sense of the minimal residual power, which is the sum of the residual power of training sequence and the noise power. CIR selector 518 generates the final estimate ĥ of CIR in accordance with ĥ=ĥ^{(j}^{₀}⁾, which provides the most accurate estimate from the generated set.

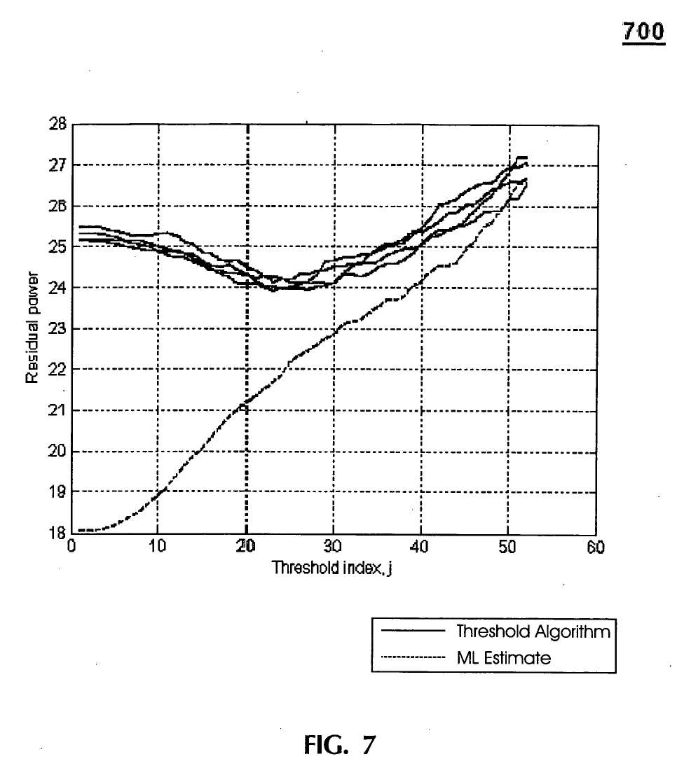

FIG. 7 is a first graph illustrating the performance of a channel estimator in accordance with one embodiment. FIG. 7 illustrates a graph 700. Graph 700 may show an example of the relation between residual power dⱼ² and the threshold index j. The lower index corresponds to the smaller threshold. The dotted curve illustrates the case when the distance dⱼ is calculated as

$${d}_{j} = ‖ {b}^{( j )} - {y}^{( 1 )} ‖$$

instead of (17). In this case the minimal distance may not be found, because y⁽¹⁾ was used for obtaining of the ML CIR estimate. The solid curves relate to the case when dⱼ is calculated as (17). Due to other noise realization the minimal distance can always be found.

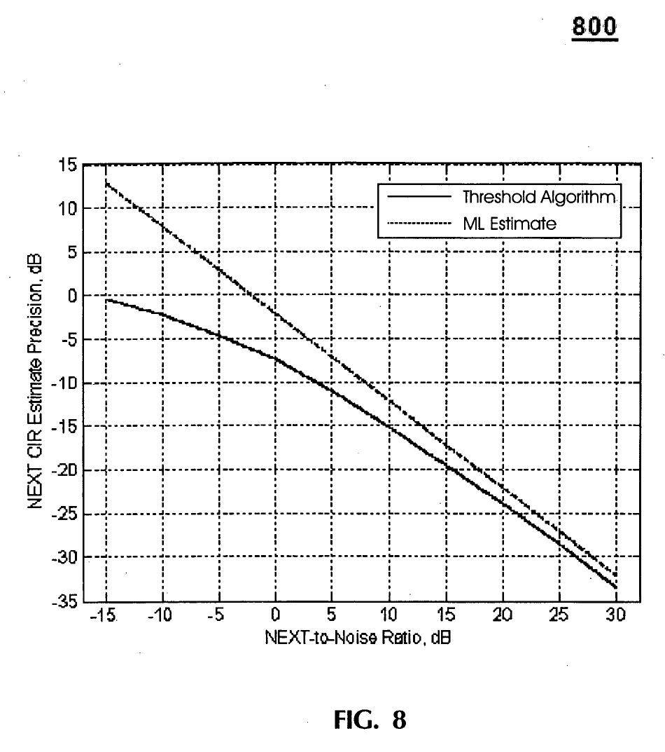

FIG. 8 is a second graph illustrating the performance of a channel estimator in accordance with one embodiment. FIG. 8 illustrates a graph 800. Graph 800 may show an estimated precision of impulse responses for NEXT of UTP cable using both ML estimation and ML estimation improved using the threshold scheme. For purposes of this example, the training sequence length may be 3047 and the CIR length is 1024. As shown in FIG. 8, the ML estimation modified using the threshold technique provides a more accurate CIR estimate than the ML estimation technique used alone, particularly for low signal-to-noise ratios.

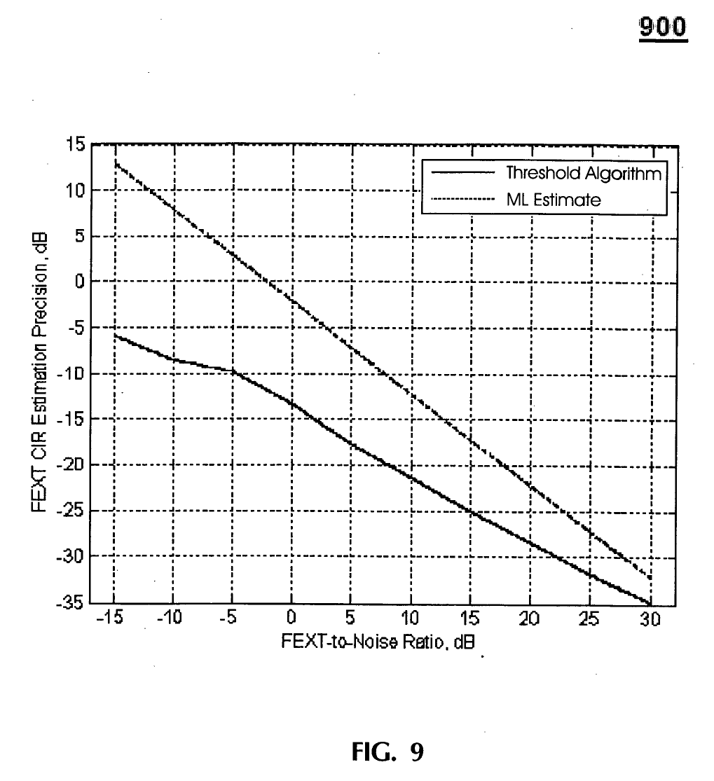

FIG. 9 is a third graph illustrating the performance of a channel estimator in accordance with one embodiment. FIG. 9 illustrates a graph 900. Graph 900 may show an estimated precision of impulse responses for FEXT of UTP cable using both ML estimation and ML estimation improved using the threshold scheme. Assuming the same training sequence length of 3047 and CIR length of 1024, graph 900 illustrates the greater accuracy of the ML estimation technique modified using the threshold scheme relative to the ML estimation technique used alone.

In accordance with a variation of the channel estimation technique described above, another embodiment may further refine the final CIR estimate in an attempt to get an improved final CIR estimate. Once the first final CIR estimate is obtained as previously described, the channel estimation technique may be repeated a second time to yield a second final CIR estimate. During the second iteration, however, the first and the second received training sequences may be swapped. For example, a second ML estimate may be obtained during the second iteration using the second received training sequence. The second ML estimate may be used to generate a second set of thresholds, candidate CIR estimates and vectors. A set of distances may be calculated between the second set of generated vectors and the first received training sequence. The minimal distance may be used to select the second final CIR estimate from the second generated set of candidate CIR estimates. The first and second final CIR estimates may then be averaged together to find a refined final CIR estimate.

In accordance with another variation of the channel estimation technique described above, another embodiment may use more than two received training sequences to generate the final CIR estimate. For example, in one embodiment the receiver may receive M training sequences, where M≧2. An i-th final CIR estimate may be obtained for every received training sequence. This may be accomplished by obtaining an ML estimate of the CIR using the i-th received training sequence. A set of thresholds may be generated using the ML estimate. The set of thresholds may be used to generated a set of candidate CIR estimates. A set of vectors may be generated by filtering the training sequence through the candidate CIR estimates. An averaged received training sequence may be found by averaging the other M-1 received training sequences, where all received training sequences except the last are used to find the average. A set of distances may be calculated between the averaged training sequence and the set of vectors. A minimum distance may be found from the set of distances. The i-th final CIR estimate may be selected from the set of candidate CIR estimates which corresponds to the minimum distance. The final CIR estimate may be found by averaging the M final CIR estimates.

The embodiments may be implemented using an architecture that may vary in accordance with any number of factors, such as desired computational rate, power levels, heat tolerances, processing cycle budget, input data rates, output data rates, memory resources, data bus speeds and other performance constraints. For example, one embodiment may be implemented using software executed by a processor. The processor may be a general-purpose or dedicated processor, such as a processor made by Intel® Corporation, for example. The software may comprise computer program code segments, programming logic, instructions or data. The software may be stored on a medium accessible by a machine, computer or other processing system. Examples of acceptable mediums may include computer-readable mediums such as read-only memory (ROM), random-access memory (RAM), Programmable ROM (PROM), Erasable PROM (EPROM), magnetic disk, optical disk, and so forth. In one embodiment, the medium may store programming instructions in a compressed and/or encrypted format, as well as instructions that may have to be compiled or installed by an installer before being executed by the processor. In another example, one embodiment may be implemented as dedicated hardware, such as an Application Specific Integrated Circuit (ASIC), Programmable Logic Device (PLD) or Digital Signal Processor (DSP) and accompanying hardware structures. In yet another example, one embodiment may be implemented by any combination of programmed general-purpose computer components and custom hardware components. The embodiments are not limited in this context.

While certain features of the embodiments of the invention have been illustrated as described herein, many modifications, substitutions, changes and equivalents will now occur to those skilled in the art. It is, therefore, to be understood that the appended claims are intended to cover all such modifications and changes as fall within the true spirit of the embodiments of the invention.

1. A method to perform channel estimation, comprising:
receiving a first training sequence;
estimating a maximum likelihood estimate of a channel impulse response using said first received training sequence;
receiving a second training sequence; and
estimating at least one channel impulse response estimate using said maximum likelihood estimate and said second received training sequence.

2. The method of claim 1, wherein estimating said maximum likelihood estimate comprises:
filtering said first received training sequence using a filter matched to said first received training sequence to form a first set of vectors for a matrix; and
transforming said matrix to form said maximum likelihood estimate.

3. The method of claim 1, wherein estimating said channel impulse response estimate comprises:
receiving said maximum likelihood estimate;
generating a set of threshold values using said maximum likelihood estimate;
generating a set of candidate channel impulse response estimate vectors using said threshold values; and
selecting said channel impulse response estimate from said candidate channel impulse response estimate vectors.

4. The method of claim 3, wherein generating said set of threshold values solves the following equation:
$${t}_{j} = \frac{{max}_{k = 0 , L - 1} \vert {\hat{h}}_{k}^{ML} \vert}{N} j$$
where t=[t₁, . . . , t_{N}] is a set of thresholds, j=1, . . . , N, L represents a channel impulse response length,ĥ^{ML} represents said maximum likelihood estimate, ĥₖ^{ML} represents the k-th tap of maximum likelihood estimate of said channel impulse response, and k=0, . . . , L−1.

5. The method of claim 3, wherein generating said set of candidate channel impulse response estimate vectors solves the following equation:
$${\hat{h}}_{k}^{( j )} = \{ \begin{matrix}{\hat{h}}_{k}^{ML} , & if \vert {\hat{h}}_{k}^{ML} \vert \geq {t}_{j} \\ 0 , & if \vert {\hat{h}}_{k}^{ML} \vert < {t}_{j}\end{matrix}$$
where ĥ^{(j)}=[ĥ⁽¹⁾, . . . , ĥ^{(N)}] is a set of candidate channel impulse response estimates, j=1, . . . , N, ĥₖ^{(j)} is k-th tap of j-th candidate channel impulse response estimate vectors, t=[t₁, . . . , t_{N}] is a set of thresholds, and ĥ^{ML} represents said maximum likelihood estimate.

6. The method of claim 3, wherein said selecting comprises:
filtering said first received training sequence using said candidate channel impulse response estimate vectors to form a second set of vectors;
determining a set of distance values between said second set of vectors and said second received training sequence;
selecting a minimum distance value from said set of distance values; and
selecting said channel impulse response estimate vector using said minimum distance value.

7. The method of claim 1, further comprising:
receiving said channel impulse response estimate at a crosstalk filtering module to form a channel impulse response matrix;
creating a crosstalk suppression filter matrix based on said channel impulse response matrix; and
filtering a plurality of data streams received over a channel for a multiple input multiple output system to reduce crosstalk between said data streams using said crosstalk suppression filter matrix.

8. A system, comprising:
a maximum likelihood estimator to generate a maximum likelihood estimate using a first received training sequence; and
a channel tap estimator to couple to said maximum likelihood estimator, said channel tap estimator to receive said maximum likelihood estimate and a second received training sequence, said channel tap estimator to generate at least one channel impulse response estimate using said maximum likelihood estimate and said second received training sequence.

9. The system of claim 8, wherein said maximum likelihood estimator comprises:
a filter to receive said first received training sequence, said filter to filter said first received training sequence to form a first set of vectors for a matrix; and
a matrix transformer to transform said matrix to form said maximum likelihood estimate.

10. The system of claim 8, wherein said channel tap estimator comprises:
a threshold generator to receive said maximum likelihood estimate and generate a set of threshold values using said maximum likelihood estimate;
a candidate channel impulse response generator to receive said threshold values, and to generate a set of candidate channel impulse response estimate vectors using said threshold values; and
a channel impulse response selector to receive said candidate channel impulse response estimate vectors and a minimum distance value, said channel impulse response selector to use said candidate channel impulse response estimate vectors and said minimum distance value to select said channel impulse response estimate.

11. The system of claim 8, further comprising:
a filter to receive said first received training sequence and said candidate channel impulse response estimate vectors, said filter to filter said first received training sequence using said candidate channel impulse response estimate vectors to form a second set of vectors;
a distance calculator to receive a second training sequence and said second set of vectors, said distance calculator to determine a set of distance values between said second set of vectors and said second received training sequence; and
a minimum selector to receive said distance values and select a minimum distance value from said set of distance values, and output said minimum distance value to said channel impulse response selector.

12. The system of claim 8, further comprising:
a communications medium;
a plurality of transmitters to connect to said communications medium, with each transmitter to transmit a data stream over said communications medium using a communications channel;
a plurality of receivers to connect to said communications medium, said plurality of receivers to receive said data streams from said communications channel; and
a crosstalk filtering module to connect to said plurality of receivers, said crosstalk filtering module to receive said channel impulse response estimate and use said channel impulse response estimate to filter said data streams to reduce crosstalk signals incurred by said data streams during said transmission.

13. The system of claim 12, further comprising a plurality of equalizers to connect to said filtering module, said equalizers to equalize said filtered data streams using a set of substantially similar equalization parameters.

14. The system of claim 12, wherein said crosstalk filtering module comprises:
a channel impulse response matrix generator to generate a channel impulse response matrix;
a crosstalk suppression filter matrix generator to generate a crosstalk suppression filter matrix using said channel impulse response matrix; and
a filter to filter said data streams using said crosstalk suppression filter matrix.

15. An article comprising:
a storage medium;
said storage medium including stored instructions that, when executed by a processor, result in performing channel estimation by receiving a first training sequence, estimating a maximum likelihood estimate of a channel impulse response using said first received training sequence, receiving a second training sequence, and estimating at least one channel impulse response estimate using said maximum likelihood estimate and said second received training sequence.

16. The article of claim 15, wherein the stored instructions, when executed by a processor, further result in estimating said maximum likelihood estimate by filtering said first received training sequence using a filter matched to said first received training sequence to form a first set of vectors for a matrix, and transforming said matrix to form said maximum likelihood estimate.

17. The article of claim 15, wherein the stored instructions, when executed by a processor, further result in estimating said channel impulse response estimate by receiving said maximum likelihood estimate, generating a set of threshold values using said maximum likelihood estimate, generating a set of candidate channel impulse response estimate vectors using said threshold values, and selecting said channel impulse response estimate from said candidate channel impulse response estimate vectors.

18. The article of claim 17, wherein the stored instructions, when executed by a processor, further result in said selecting by filtering said first received training sequence using said candidate channel impulse response estimate vectors to form a second set of vectors, determining a set of distance values between said second set of vectors and said second received training sequence, selecting a minimum distance value from said set of distance values, and selecting said channel impulse response estimate vector using said minimum distance value.

19. The article of claim 15, wherein the stored instructions, when executed by a processor, further result in receiving said channel impulse response estimate at a crosstalk filtering module to form a channel impulse response matrix, creating a crosstalk suppression filter matrix based on said channel impulse response matrix, and filtering a plurality of data streams received over a channel for a multiple input multiple output system to reduce crosstalk between said data streams using said crosstalk suppression filter matrix.

20. The method of claim 1, further comprising:
estimating a second maximum likelihood estimate of a channel impulse response using said second received training sequence;
estimating a second channel impulse response estimate using said second maximum likelihood estimate and said first received training sequence; and
averaging said channel impulse response estimates to find an averaged channel impulse response estimate.

21. The method of claim 1, further comprising:
receiving an i-th training sequence;
estimating an M channel impulse response estimate using said i-th training sequence; and
averaging said M channel impulse response estimates to find an averaged channel impulse response estimate.
